(19) United States
(12) Patent Application Publication
(10) Pub. No.: US 2005/0078844 A1
(43) Pub. Date: Apr. 14, 2005

(54) Hearing aid with an amplifying device in a housing of a user positionable hand-held apparatus

(76) Inventor: Christoph Von Ilberg, Frankfurt/Main (DE)

Correspondence Address: STAAS & HALSEY LLP, SUITE 700, 1201 NEW YORK AVENUE, N.W., WASHINGTON, DC, 20005, US

(21) Appl. No.: 10/682,844

(22) Filed: Oct. 10, 2003

(51) Int. Cl. H04R 25/00

(52) U.S. Cl. 381/322; 381/370; 381/374; 381/380; 381/312

(57) ABSTRACT

A hearing aid comprises at least one ear-piece unit to be placed in or at an user's ear, said ear-piece unit having at one side thereof a loudspeaker unit and at another side thereof a microphone unit, said hearing aid further comprising at least one amplifying device adapted to amplify electrical signals received from the microphone unit to deliver the amplified electrical signals to the loudspeaker unit, wherein said amplifying device communicates with the microphone unit and the loudspeaker unit and can be worn or supported at the upper part of the user's body.

The present invention relates to a hearing aid, a hand-held electrical or electronical apparatus for a hearing aid, a hearing aid system, an ear-piece unit for a hearing aid, and a combined hearing aid and hands-free system.

Approximately 5% to 10% of the population suffer from impaired hearing. The degree of hearing loss ranges from mild, to moderate, to severe, to profound hearing losses on the verge of deafness, and finally, to acquired or congenital deafness. The cause for such hearing losses can lie in the region of the ear which conducts the sound wave (ear drum, middle ear), in the inner ear (cochlea), or in the auditory nerve or central auditory processing. Depending upon the cause, site, and degree of hearing difficulty, operative therapy, rehabilitation, drug therapy, or other therapies may be indicated. When these therapies are insufficient or unsuccessful, there are a variety of technical hearing aids (auditory processes) available in order to improve hearing.

From the above indicated population suffering from impaired hearing a remarkable percentage falls in the range of mild or moderate hearing loss. For many-fold reasons these people very often do not provide oneself with a conventional hearing aid for compensating ones hearing loss. First of all, a remarkable effort has to be made to obtain a suitable conventional hearing aid. At first an ear, nose and throat specialist has to be visited to diagnose a hearing loss and the degree of the hearing loss. Then an acoustician has to be consulted for the construction and fitting of a hearing aid which is normally precisely adapted or fitted to the patient's ears. Until completion of the hearing aid, a lot of time consuming tests have to be conducted with respect to the functionality of the hearing aid and the improvement of the hearing of the patient so that many people are afraid of the overall time effort. Another point is the relatively high total costs for providing oneself with a hearing aid including consulting of the medical doctor and the acoustitian or hearing aid specialist. Moreover, in many countries the state or private health insurance companies will only bear part or even nothing of the costs for a hearing aid if the degree of hearing loss does not exceed a certain predetermined level. Another important obstacle lies in the fact that conventional hearing aids are tainted with a relatively bad image. Most of the conventional hearing aids can be visually recognised and people wearing a hearing aid often experience a considerable amount of disdain from other people, in particular from younger people.

A further disadvantage of conventional hearing aids relates to their power supply which is normally solved by non-rechargeable batteries, namely button-cells. The exchange of these batteries can be a complicated and cumbersome procedure, in particular for older people. Moreover, the batteries are normally not paid by the insurance companies.

It is therefore one object of the present invention, to provide a hearing aid for mild to moderate hearing loss which does not need the consultation of a medical doctor and/or an acoustician for construction and adaptation or fitting of the hearing aid, whereas at the same time the hearing aid is relatively simple in construction and manufacturing costs can be kept at a low level.

It is a further object of the invention to provide a hand-held electrical or electronical apparatus, a hearing aid system, an ear-piece unit and a combined hearing aid and hands-free system, the aforementioned devices as parts of or working in conjunction with a hearing aid.

A hearing aid according to the present invention comprises at least one ear-piece unit to be placed in or at a user's ear, said ear-piece unit having at one side thereof a loudspeaker unit and at another side thereof a microphone unit, said hearing aid further comprising at least one amplifying device adapted to amplify electrical signals received from said microphone unit and to deliver the amplified electrical signals to said loudspeaker unit, wherein said amplifying device stays in communication with said microphone unit and said loudspeaker unit and can be worn or supported at the upper part of the user's body.

The amplifying device is preferably comprised of any kind of electronic amplifier which is placed within a housing in which also a power supply and other circuits or circuit elements for whatever purpose may be incorporated.

The ear-piece unit of the hearing aid can be of simple form and construction so as to be comparable with ear plugs of simple and conventional headphones. At the ear side of the ear-piece unit the loudspeaker unit is disposed. As in conventional headphones there can be provided foam material disposed around the loudspeaker unit at the ear side of the ear-piece unit. At an opposite side of the loudspeaker unit the microphone unit is disposed. Thus, the microphone unit is disposed so as to pick up acoustic signals from the environment. These acoustic signals are transmitted to the amplifying device where they are amplified and transmitted back to the loudspeaker unit. A volume control for controlling the output volume of the amplifier device may be disposed at the housing of the amplifier device. The amplifier device may communicate with the ear-piece unit through wirebound communication means or wireless communication means as will be explained below. Anyway the amplifying device or the apparatus housing the amplifying device is freely disposable by the user within the range of his own body. It is possible for the user, for example, to place or position the amplifying device within a pocket of his jacket or shirt or trousers. It is also possible for the user to lay down the amplifying device onto a table in his near vicinity.

In one preferred embodiment of an inventive hearing aid two ear-piece units are provided to be placed in or at the user's ears. In this case it is preferred accordingly that two amplifying devices are provided in order to amplify electrical signals coming from respective ones of the two microphone units of the two ear-piece units. The two amplifying devices may then also be housed within a housing of a suitable hand-held apparatus to be placed or positioned at the user's disposition. In the case of using two ear-piece units being connected each with one amplifying device the natural stereophonic hearing is maintained and amplified. Moreover, the directional hearing becomes possible for the user which is very important for the understanding of speech, in particular in noisy environment. Of course, the user can decide any time to put one of the ear-piece units out of one ear so that only the sound impinging at the other remaining ear-piece unit is amplified and transmitted to this ear-piece unit.

A big advantage of the inventive hearing aid lies in the fact that it is not a medical apparatus like conventional hearing aids. Thus the inventive hearing aid does not need to undergo any official technical examination and admission by official authorities like health authorities etc. In principle the inventive hearing aid could be offered in a shop or department store.

It is preferred that a volume control is provided for adjusting the output level of the amplifying device. In case of using two amplifying devices the volume of each amplifying device should be separately adjustable for the user as there may be a difference in hearing performance between the two ears. The output volume of the volume control should have an upper limit, like e.g. 100 dB.

As mentioned above, in one embodiment of the hearing aid the signal transfer between the ear-piece unit and the amplifying device occurs via a wirebound communication. In this case there is provided at least one ear-piece cable for connecting the at least one ear-piece unit with the amplifying device and each one ear-piece cable contains one signal line for connecting the microphone unit with the amplifying device and one signal line for connecting the loudspeaker unit with the amplifying device.

In one further embodiment, when using two ear-piece units, there are provided two ear-piece cables for connecting the two ear-piece units with the two amplifying devices, respectively. More preferably, the two ear-piece cables are provided at one end thereof with a common plug for connecting them with a corresponding interface socket in a housing of the amplifying devices. In addition, the two ear-piece cables can be mechanically connected together between the common plug and a branching point and are mechanically separated from each other and separately connected with their respective ear-piece units between the branching point and the ear-piece units.

The hearing aid according to the aforementioned embodiment could be extended to function also as a hands-free system in cases in which the hand-held apparatus is a mobile communication unit. This can be accomplished by the hearing aid further comprising a second microphone unit and a corresponding microphone cable for connecting said second microphone unit with the mobile communication unit, wherein preferably said ear-piece cable and said microphone cable being mechanically coupled to each other at least in part. According to the user's choice two different modes can be activated at the mobile communication unit. In a first mode the mobile communication unit is not used for any mobile communication so that the hearing aid mode can be activated as described above. In a second mode the mobile communication unit is used for speech or data transmission with another communication unit and the hands-free mode is activated. In this case the second microphone unit is active so that the user's speech is picked up by the second microphone and transmitted by the mobile communication unit to the remote communication unit and communication signals are received by the mobile communication unit, amplified by the amplifying device and delivered to the loudspeaker unit of the ear-piece unit.

In another embodiment of the hearing aid the communication between the ear-piece unit and the amplifying device occurs by wireless communication in which case a first wireless transmitting and receiving unit is coupled to said at least one ear-piece unit and a second wireless transmitting and receiving unit is coupled to said at least one amplifying device, said first transmitting and receiving unit is adapted for transmitting electrical signals received from said microphone unit to said second transmitting and receiving unit and for receiving amplified signals transmitted from said second transmitting and receiving unit and said second transmitting and receiving unit is adapted for receiving signals transmitted from said first transmitting and receiving unit and for delivering them to said at least one amplifying device and for transmitting amplified electrical signals to said first transmitting and receiving unit, and wherein the wireless communication occurs by radio waves, ultra sound waves or infrared electro-magnetic waves. In case of using two ear-piece units and two respective amplifying devices there can be provided one transmitting and receiving unit on each one of the ear-piece units and one transmitting and receiving unit at the hand-held apparatus.

In the afore described embodiment the wireless communication can occur via a Bluetooth, DECT, WDCT or wireless LAN connection.

As mentioned above, the at least one amplifying device can be built into a housing which may also contain a power supply and further electronic devices or circuits for other functions. Therefore, in another embodiment the hearing aid may further comprise a hand-held electrical or electronical apparatus containing said at least one amplifying device. The hand-held apparatus may be a mobile communication unit, a smart phone, an organiser, a computer, a calculator, an electronic data base, a personal digital assistant (PDA) or an MP3 player.

In a further embodiment said hand-held apparatus may comprise a display and means for displaying on said display a graphical element or icon representing the hearing aid function. The display could further be a touch-screen display and the hearing aid function could be activated by touching the graphical element or icon representing the hearing aid function.

The present invention also relates to a hearing aid system, comprising two ear-piece units to be placed in or at the user's ears, each one of said ear-piece units comprising on one side thereof a loudspeaker unit and on another side thereof a microphone unit, two ear-piece cable for connecting said two ear-piece units with at least one amplifying device, each one of said ear-piece cables containing an electrical signal connected with said microphone unit and one electrical signal line connected with said loudspeaker unit, wherein said two ear-piece cables are provided at one end with a common plug for connecting them with a corresponding interface socket in a housing of the amplifying device.

In a further preferred embodiment thereof said two ear-piece cables are combined into one single cable in a branching point and said one single cable is provided at its opposing end with said common plug.

The present invention also relates to a hand-held electrical or electronical apparatus to be worn or supported at the upper part of a user's body and adapted to communicate with a microphone unit and a loudspeaker unit of an ear-piece unit of a hearing aid, said hand-held apparatus adapted for receiving electrical signals from said microphone unit, for amplifying the electrical signals and for delivering the amplified electrical signals to said loudspeaker unit.

In one embodiment of the hand-held electrical or electronical apparatus such apparatus is adapted for a wirebound communication with said microphone unit and said loudspeaker unit by further comprising an input line connector for receiving electrical signals from said microphone unit, an amplifying device for amplifying the electrical signals and an output line connector for delivering the amplified electrical signals to said loudspeaker unit. More preferably, there is provided at one side of the housing of the apparatus an interface socket including the input and output line connectors. In this way a common plug of a hearing aid system combining one or more cables from the ear-piece units can be plugged into the interface socket in one motion. If the hand-held apparatus is a mobile communication unit, the interface socket could be identical with the interface socket as provided for the plug-in of a hands-free system.

In another embodiment, as already described above with respect to the hearing aid, the hand-held electrical or electronical apparatus could also be adapted for a wireless communication with the microphone unit and the loudspeaker unit, by further comprising a second wireless transmitting and receiving unit for communicating with a first ear-piece unit wireless transmitting and receiving unit, said second transmitting and receiving unit adapted for receiving signals transmitted from said first transmitting and receiving unit and for transmitting amplified electrical signals to said first transmitting and receiving unit, wherein the wireless communication occurs by radio waves, ultra sound waves or infrared electromagnetic waves. The wireless communication could occur by a Bluetooth, DECT, WDCT or wireless LAN (WLAN) connection.

The hand-held electrical or electronical apparatus can also be a smart phone, an organiser, a computer, a calculator, an electronic data base, a personal digital assistant (PDA) or a MP3 player.

In a further embodiment the hand-held apparatus comprises a display and means for displaying on said display a graphical element or icon representing the hearing aid function. The display can be a touch-screen display and the hearing aid function is to be activated by touching the graphical element or icon representing the hearing aid function.

The present invention also relates to an ear-piece unit to be placed in or at a user's ear and comprising on one side thereof a loudspeaker unit and on another side thereof a microphone unit, and a first wireless transmitting and receiving unit for communicating with a second transmitting and receiving unit, said second transmitting and receiving unit being connected with an amplifying device, wherein said first transmitting and receiving unit is adapted for transmitting electrical signals received from said microphone unit to said second transmitting and receiving unit and for receiving amplified signals transmitted from said second transmitting and receiving unit, wherein the wireless communication occurs by radio waves, ultra sound waves or infrared electromagnetic waves. Preferably the wireless communication occurs by a Bluetooth, DECT, WDCT or wireless LAN (WLAN) connection.

In a preferred embodiment there are provided two ear-piece units to be placed in the user's ears and connected with each other by a rope or a rigid bar.

In all of the afore-mentioned embodiments it can be arranged that the signals are not only amplified but also processed, e.g. by means of a digital signal processor (DSP). In particular, the signal can be filtered by hardware filters or fourier transformation and elimination of unwanted frequencies in the DSP. By use of a cell phone the DSP of the cell phone can be used for these functions. Within the hearing aid function of the cell phone it is also possible to suppress unwanted frequencies or selectively amplify or suppress the frequencies of the input signal.

The invention will be more readily understood by reference to the following description, taken with the accompanying drawings, in which:

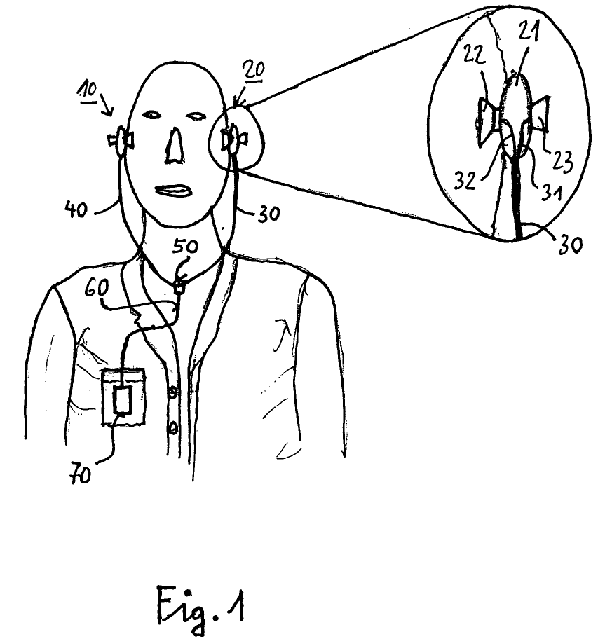

FIG. 1 depicts a first embodiment of a hearing aid according to the present invention in operation by a user.

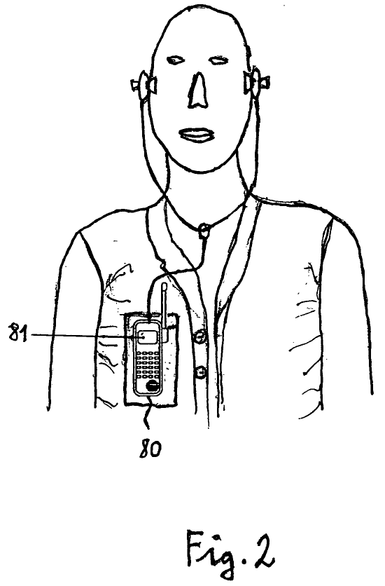

FIG. 2 a second embodiment of a hearing aid according to the present invention in operation by a user.

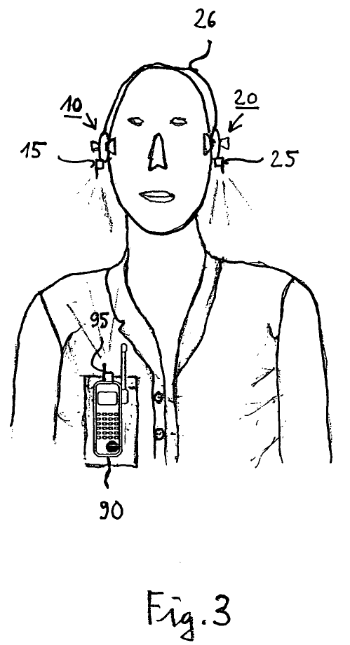

FIG. 3 a third embodiment of a hearing aid according to the present invention in operation by a user.

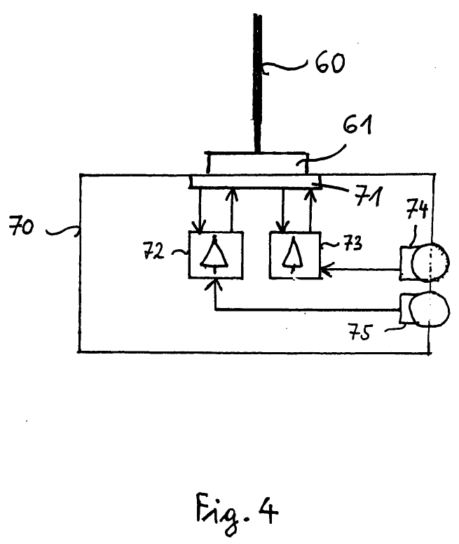

FIG. 4 an embodiment of a hand-held apparatus, comprising two amplifying devices.

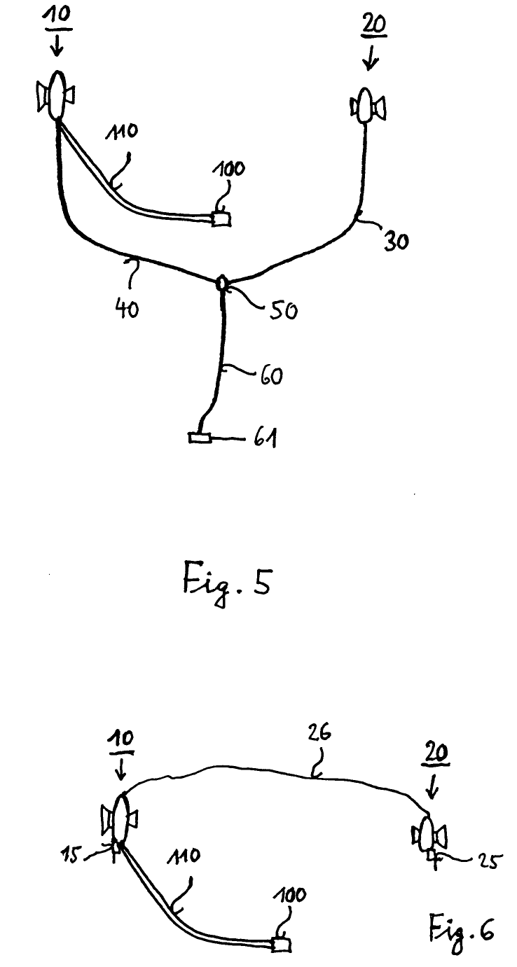

FIG. 5 an embodiment of a combined hearing aid and hands-free system.

FIG. 6 a further embodiment of a combined hearing aid and hands-free system.

In FIG. 1 the user of a first embodiment of an inventive hearing aid is shown. The user has applied to his ears, respectively, ear-piece units 10 and 20. The structure of the ear-piece units is shown in an enlarged section on the right side. The ear-piece unit 20 is comprised of a main body 21 which serves for securing thereto a loudspeaker unit 22 and a microphone unit 23. The main body part 21 should also serve for a good sound isolation between the loudspeaker unit 22 and the microphone unit 23 in order to prevent the feedback of amplified sound signals from the loudspeaker unit 22 to the microphone unit 23. The main body part 21 has outer dimensions to fit into the opening of a human ear and can be provided with foam material disposed around the loudspeaker unit 22. The loudspeaker unit 22 is in the plug-in position directed into the entrance of the ear and the microphone unit 23 is applied so as to pick up the sound from the environment.

A signal line 31 is connected with the microphone unit 23 and a signal line 32 is connected with the loudspeaker unit 22. The signal line 31 serves for transmitting electrical signals generated by the microphone unit 23 out of sound signals and the signal line 32 carries amplified electrical signals to be converted into sound signals in the loudspeaker unit 22. The electrical signal lines 31 and 32 are hold together in a cable 30. Additional power supply lines, which are not shown for sake of clarity, can be provided for the microphone unit 23 and the loudspeaker unit 22.

The other ear-piece unit 10 is constructed in an identical manner. It is connected with a cable 40 carrying the signal lines from the respective microphone and loudspeaker units. The two ear-piece cables 30 and 40 are combined in a branching point 50 and connected with the branching point 50 is a cable 60 which supports the electrical signal lines of both ear-piece cables 30 and 40. The cable 60 is connected with a hand-held apparatus 70 which can be placed within a pocket of the user's jacket as shown in the figure. In one most easy and simple embodiment the hand-held apparatus 70 is comprised of nothing more than a housing and one or more amplifying devices incorporated into the housing which is depicted in FIG. 4.

According to FIG. 4 the cable 60 is connected with a plug 61 to be plugged into an interface socket 71 of the hand-held apparatus 70. The interface socket 71 is connected with two electronic amplifiers 72 and 73. These amplifiers 72 and 73 are supplied with electrical signals from the microphone units of the ear-piece units 10 and 20, respectively, and deliver amplified electrical output signals to the respective loudspeaker units of the ear-piece units 10 and 20. In volume tuning sections 74 and 75 the output volume of the amplifiers 72 and 73 can be continuously adjusted by the user by turning wheels which extend out of the housing of the apparatus 70. A first volume section 74 is connected with the amplifier 73 and a second volume tuning section 75 is connected with the amplifier 72. The two amplifiers 72 and 73 amplify the electrical signals from the ear-piece units 10 and 20, respectively, so that the natural stereophonic hearing is maintained with the amplification. The two volume tuning sections serve for compensating for an imbalance in hearing loss of the two ears.

Alternatively, there can be provided only one amplifying device for receiving and amplifying the electrical signals from both ear-piece units 10 and 20. Within the housing of the apparatus 70 a power supply (not shown) can be disposed at a suitable position.

In addition there can be provided a balance control of low and high frequency tones which can be constructed as well known by a skilled artisan. The balance control could be connected with another wheel which extends out of the housing and can be turned by the user.

It solely depends on the user's decision where he wants to wear or place the hand-held apparatus 70 at his body or his clothes. There can be provided means for adjusting the length of the cable 60 so that the user would be enabled to place the apparatus 70 at even more remote positions, like e.g. pockets in his trousers.

A second embodiment is depicted in FIG. 2, wherein the hand-held apparatus is a cell phone (mobile communication unit) 80. In the cell phone 80 the electronic amplifiers could be mounted on the printed circuit board. On the display 81 of the cell phone 80 an icon for the hearing aid function could be displayed together with other icons for other functions so that the hearing aid icon could be selected, e.g. by touching with a touch pad in case of a touch screen display. Preferably the interface socket for receiving the plug 61 is an interface socket which is anyway present at conventional cell phones so that no extra socket would have to be provided. For example, almost all cell phones are nowadays produced with an interface socket for the plug-in of a hands-free system. This interface socket could also be used for the plug-in of the plug 61 of the hearing aid system. When the hearing aid function is activated the interface socket will be connected internally with the amplifying devices and when the hands-free function is activated the interface socket will be connected internally with a voice input/output section of the cell phone 80. The cell phone 80 can also have volume tuning sections 74 and 75 as shown in FIG. 4. Alternatively, the output volumes of the amplifying devices could be controlled by push buttons on the push button section of the cell phone 80. Also an additional balance control of high and low frequency tones could be realised by push buttons on the push button section.

In FIG. 3 a further embodiment of a hearing aid is depicted in which a cell phone 90 communicates by wireless communication with the two ear-piece units 10 and 20. For this purpose the ear-piece units are provided with Bluetooth transmitting and receiving units 15 and 25 and the cell phone 90 is also provided with a Bluetooth transmitting and receiving unit 95.

In this embodiment, however, the ear-piece units 10 and 20 would have to be provided with power supply means for the Bluetooth units. The electrical signal from the microphone units of the ear-piece units 10 and 20 could be provided with a specific code before sent out by the Bluetooth devices 15 and 25 so that after reception of the signals by the Bluetooth device 95 the origin of the electrical signals from either one of the Bluetooth devices 15 and 25 could be distinguished by suitable means in the cell phone 90 and distributed to two amplifying devices. Also the amplified electrical signals can be provided with a specific code and then sent out by the Bluetooth device 95 so that the amplified electrical signals could be correctly assigned to the Bluetooth devices 15 and 25. Thus, a stereophonic hearing is maintained within the hearing aid system. The ear-piece units 10 and 20 can be connected with a rope 26 or with a rigid bar.

Alternatively there can be provided two Bluetooth devices in the cell phone 90 to communicate with the ear-piece units, respectively.

The number of cell phones fabricated with integrated Bluetooth transmitting and receiving devices is steadily increasing. The Bluetooth devices are intended for the communication with wireless hands-free systems. Therefore the additional costs of the embodiment according to FIG. 3 as compared with the embodiment of FIG. 2 are only related to the two Bluetooth devices of the two ear-piece units.

In FIG. 5 a combined hearing aid and hands-free system is depicted. In addition to the hearing aid cable system as shown in FIGS. 1 and 2 a further microphone 100 is provided for picking up the voice of the user and to convert it to an electrical signal to be transmitted to the cell phone. The speech microphone 100 could be secured as shown at one of the ear-piece units with a rigid bar 110. Alternatively, the speech microphone 100 could also be integrated into one of the cables 30, 40 or 60 or into the branching point 50. In case of the activation of the hands-free function at the cell phone, the speech microphone 100 is activated and electrical signals from the speech microphone 100 are transmitted by an electrical line in the rigid bar 110 and the cables 40 and 60 into the cell phone and into the voice input/output section. When the cell phone receives signals from a remote communication side these signals will be delivered from the voice input/output section to the plug 61 and the cables 30, 40 and 60 to the loudspeaker units of the ear-piece units 10 and 20. In addition, it could be arranged that the amplifier devices for the hearing aid function also amplify the voice output signal to be delivered to the loudspeaker units in case of the activation of the hands-free functions.

Another embodiment of a combined hearing aid and hands-free system as depicted in FIG. 6 could be provided on the basis of the hearing aid system of FIG. 3. In this case a microphone 100 secured to a rigid bar 110 could be mounted at one of the two ear-piece units 10 or 20, which are provided with Bluetooth devices 15 or 25, respectively. In case of the hands-free function the microphone 100 picks up the user's voice and converts the acoustical signal into an electrical signal. The electrical signal is transmitted by a signal line within the rigid bar 110 to a Bluetooth device 15 and transmitted via wireless transmission to the Bluetooth device 95 of the cell phone 90. In the hands-free function the Bluetooth device 95 of the cell phone 90 is connected with the voice input/output section. In the hearing aid function the Bluetooth device 95 of the cell phone 90 is connected with the amplifying devices.

1. A hearing aid, comprising
at least one ear-piece unit to be placed in or at a user's ear,
said ear-piece unit having on one side thereof a loudspeaker unit and on another side thereof a microphone unit,
said hearing aid further comprising at least one amplifying device adapted to amplify electrical signals received from the microphone unit and to deliver the amplified electrical signals to the loudspeaker unit, wherein said amplifying device communicates with the microphone unit and the loudspeaker unit, wherein said amplifying device communicates with the microphone unit and the loudspeaker unit and can be worn or supported at the upper part of the user's body.

2. A hearing aid according to claim 1, comprising two ear-piece units to be placed in or at the user's ears and two amplifying devices, each one of said amplifying devices communicating with one of said ear-piece units.

3. A hearing aid according to claim 1, further comprising at least one ear-piece cable for connecting the at least one ear-piece unit with the amplifying device, each one ear-piece cable containing one line for connecting the microphone unit with the amplifying device and one line for connecting the loudspeaker unit with the amplifying device.

4. A hearing aid according to claims 2 and 3, comprising two ear-piece cables for connecting said two ear-piece units with the two amplifying devices, respectively, wherein said two cables are provided at one end with a common plug for connecting them with a corresponding interface socket in a housing of the amplifying devices and said two ear-piece cables are mechanically connected together between the common plug and a branching point and are mechanically separated from each other and separately connected with their respective ear-piece units between the branching point and the ear-piece units.

5. A hearing aid according to claim 1, further comprising a first wireless transmitting and receiving unit coupled to said at least one ear-piece unit, said hearing aid further comprising a second wireless transmitting and receiving unit coupled to said at least one amplifying device, said first transmitting and receiving unit adapted for transmitting electrical signals received from said microphone unit to said second transmitting and receiving unit and for receiving amplified signals transmitted from said second transmitting and receiving unit and said second transmitting and receiving unit adapted for receiving signals transmitted from said first transmitting and receiving unit and for delivering them to said at least one amplifying device and for transmitting amplified electrical signals to said first transmitting and receiving device, and wherein the wireless communication occurs by radio waves, ultra sound waves or infrared electromagnetic waves.

6. A hearing aid according to claim 5, wherein the wireless communication occurs by a Bluetooth, DECT, WDCT or wireless LAN connections.

7. A hearing aid according to claim 1, further comprising a hand-held electrical or electronical apparatus containing said at least one amplifying device.

8. A hearing aid according to claim 7, wherein the hand-held apparatus is a mobile communication unit, a smart phone, an organiser, a computer, a calculator, an electronic data base, a personal digital base, a personal digital assistant (PDA) or a MP3 player.

9. A hearing aid according to claim 7, wherein said hand-held apparatus comprises a display and means for displaying on said display a graphical element or icon representing the hearing aid function.

10. A hearing aid according to claim 9, wherein said display is a touch-screen display and the hearing aid function is to be activated by touching the graphical element or icon representing the hearing aid function.

11. A hearing aid according to claims 3 and 8, wherein the hand-held apparatus is a mobile communication unit and said hearing aid further comprising a second microphone unit and a microphone cable for connecting said second microphone unit with the mobile communication unit, said ear-piece cable and said microphone cable being mechanically coupled to each other at least partly.

12. A hand-held electrical or electronical apparatus to be worn or supported at the upper part of an user's body and adapted to communicate with a microphone unit and a loudspeaker unit of an ear-piece unit of a hearing aid, said hand-held apparatus adapted for receiving electrical signals from said microphone unit, for amplifying the electrical signals and for delivering the amplified electrical signals to said loudspeaker unit.

13. A hand-held electrical or electronical apparatus according to claim 12, adapted for a wire bound communication with said microphone unit and said loudspeaker unit by further comprising an input line connector for receiving electrical signals from said microphone unit, an amplifying device for amplifying the electrical signals and an output line connector for delivering the amplified electrical signals to said loudspeaker unit.

14. A hand-held electrical or electronical apparatus according to claim 12, further comprising an interface socket including input and output line connectors.

15. A hand-held electrical or electronical apparatus according to claim 12, adapted for a wireless communication with said microphone unit and said loudspeaker unit by further comprising a second wireless transmitting and receiving unit for communicating with a first ear-piece unit wireless transmitting and receiving unit, said second transmitting and receiving unit adapted for receiving signals transmitted from said first transmitting and receiving unit and for transmitting amplified electrical signals to said first transmitting and receiving unit, wherein the wireless communication occurs by radio waves, ultra sound waves, or infrared electromagnetic waves.

16. A hand-held electrical or electronical apparatus according to claim 15, wherein the wireless communication occurs by a Bluetooth, DECT, WDCT or wireless LAN connection.

17. A hand-held electrical or electronical apparatus according to claim 12, further comprising a display and means for displaying on said display a graphical element or icon representing the hearing aid function.

18. A hand-held electrical or electronical apparatus according to claim 17, wherein said display is a touch-screen display and the hearing aid function is to be activated by touching the graphical element or icon respresenting the hearing aid function.

19. A hand-held electrical or electronical apparatus according to claim 12, wherein the hand-held apparatus is a mobile communication unit, a smart phone, an organiser, a computer, a calculator, an electronic data-base, a personal digital assistant (PDA) or a MP3 player.

20. A hearing aid system, comprising two ear-piece units to be placed in or at the user's ears, each one of said ear-piece units comprising on one side thereof a loudspeaker unit and on another side thereof a microphone unit, two ear-piece cables for connecting said two ear-piece units with at least one amplifying device, each one of said ear-piece cables containing an electrical signal connected with said microphone unit and one electrical signal line connected with said loudspeaker unit, wherein said two ear-piece cables are provided at one end thereof with a common plug for connecting them with a corresponding interface socket in a housing of the amplifying device.

21. A hearing aid system according to claim 20, wherein said two ear-piece cables are combined into one single cable in a branching point and said one single cable is provided at its opposing end with said common plug.

22. An ear-piece unit to be placed in or at an user's ear, comprising on one side thereof a loudspeaker unit and on another side thereof a microphone unit, a first wireless transmitting and receiving unit for communicating with a second transmitting and receiving unit connected with an amplifying device, wherein said first transmitting and receiving unit is adapted for transmitting electrical signals received from said microphone unit to said second transmitting and receiving unit and for receiving amplified signals transmitted from said second transmitting and receiving unit, wherein the wireless communication occurs by radio waves, ultra sound waves or infrared electro-magnetic waves.

23. An ear-piece unit according to claim 22, wherein the wireless communication occurs by a Bluetooth, DECT, WDCT or wireless LAN connection.

24. A combined hearing aid and hands-free system for use in connection with a mobile communication unit, said mobile communication unit comprising at least one amplifying device, said combined hearing aid and hands-free system comprising at least one ear-piece unit to be placed in or at a user's ear, said ear-piece unit having on one side thereof a loudspeaker unit and on another side thereof a first microphone unit, at least one ear-piece cable for connecting the at least one ear-piece unit with the mobile communication unit, a second microphone unit and a microphone cable for connecting said second microphone unit with the mobile communication unit, said ear-piece cable and said microphone cable being mechanically coupled to each other at least partly.

25. A combined hearing aid and hands-free system for use in connection with a mobile communication unit, said mobile communication unit comprising at least one amplifying device, said combined hearing aid and hands-free system comprising at least one ear-piece unit to be placed in or at a user's ear, said ear-piece unit having on one side thereof a loudspeaker unit and on another side thereof a first microphone unit, a first wireless transmitting and receiving unit for communicating with a second transmitting and receiving unit connected with the amplifying device, wherein said first transmitting and receiving unit is adapted for transmitting electrical signals received from said microphone unit to said second transmitting and receiving unit and for receiving amplified signals transmitted from said second transmitting and receiving unit, wherein the wireless communication occurs by radio waves, ultra sound waves or infrared electro-magnetic waves.
